(19) United States
(12) Patent Application Publication
(10) Pub. No.: US 2024/0382955 A1
(43) Pub. Date: Nov. 21, 2024

(54) A MICROFLUIDIC ARRANGEMENT

(71) Applicant: miDiagnostics NV, Heverlee (BE)

(72) Inventors: David Mikaelian, Heverlee (BE); Benjamin Jones, Leuven (BE); Giuseppe Fiorentino, Leuven (BE)

(21) Appl. No.: 18/693,888

(22) PCT Filed: Sep. 23, 2022
(86) PCT No.: PCT/EP2022/076502

§ 371 Date: Mar. 20, 2024

(30) Foreign Application Priority Data
Sep. 24, 2021 (EP) 21198939.7

(51) Int. Cl. B01L 3/00

(52) U.S. Cl. CPC B01L 3/502738; B01L 2300/0809; B01L 2400/0633

(57) ABSTRACT

A present inventive concept relates to a microfluidic arrangement comprising: a first section having a first plane and comprising a trigger channel and a stop channel, wherein the trigger channel and the stop channel are parallel with the first plane; wherein the trigger channel has a first portion having a first depth, and a second portion having a second, deeper, depth, the trigger channel being arranged to allow a liquid flow to the second portion from the first portion; and wherein the stop channel has an opening that fluidically connects the stop channel to the second portion of the trigger channel at a predetermined distance from a bottom of the trigger channel; the microfluidic arrangement further comprising: a second section having a second plane having a third portion comprising a plurality of elongated recesses, wherein the plurality of recesses are arranged separated from each other; wherein the first section and the second section are arranged with the first and the second planes in parallel, and adjacent or coinciding, and such that the third portion overlaps the opening, or such that the third portion is adjacent to the opening, whereby a recess of the plurality of recesses is arranged to stop a liquid flow from the stop channel to the trigger channel. A further present inventive concept relates to a microfluidic trigger valve.

### TECHNICAL FIELD

The present inventive concepts relate to a microfluidic arrangement, a microfluidic trigger valve, a microfluidic system comprising the microfluidic arrangement or the trigger valve, and a diagnostic device comprising the microfluidic system.

### Technical Background

Capillary valves are passive non-mechanical valves that utilise interfacial surface tension to stop or restrict flow of liquid in a channel, and that utilise capillary flow for providing flow of liquid. A capillary trigger valve is a capillary valve in which a stopped flow can be triggered to restart by means of another flow of liquid. Trigger valves may be used in, for example, microfluidic systems, such as microfluidic analytical systems.

A typical capillary trigger valve may consist of three channels: (i) a stop channel where liquid flow is stopped at a valve junction, (ii) a trigger channel where fluid flows to trigger or restart the flow in the stop channel, and (iii) an outlet channel that allows the trigger flow and stop flow to continue further beyond the valve junction.

In one type of capillary trigger valve, the stop channel mouths at a right angle into the trigger flow channel, at a side wall of the trigger flow channel. To avoid leakage of liquid from the stop channel into the capillary trigger valve before the stopped flow has been triggered, the capillary trigger valve can have a recess above the outlet of the stop flow channel and a deeper portion below the outlet of the stop flow channel, thus providing further distances from the outlet of the stop flow channel and the bottom and the ceiling parts of the capillary trigger valve at the junction.

It is a problem with the above type of capillary trigger valves that gas bubbles, such as air bubbles, may emerge and/or be trapped in the recess or the deeper portion as fluid advances into the capillary trigger valve. Such bubbles are disadvantageous as they may result in undesired termination of capillary flows or restrict capillary flows. Further, such bubbles may disturb downstream processes, such as analysis and detection of samples or sample components.

Manufacturing of capillary trigger valves having the above discussed recess, is further problematic as it typically involves positioning and bonding of a top wafer having the recess on top of a bottom wafer having the channels and the deeper portion. Due to tolerances in wafer to wafer bonding, the recess may not be sufficiently well aligned with the structures in the bottom wafer. It is problematic and difficult, sometimes not possible, to make the positioning and bonding with sufficient accuracy to provide a functioning trigger valve, where the flow of liquid is desirably stopped, without leakage, in the stop flow channel at the capillary stop valve.

There is a need to avoid or tackle problems associated with bubble formation and/or other type of malfunctioning or problems associated with capillary trigger valves.

### SUMMARY OF INVENTION

It is an object to mitigate, alleviate or eliminate one or more of above-identified deficiencies in the art and disadvantages singly or in any combination and solve at least one above indicated problem.

According to a first aspect of the present inventive concept, there is provided a microfluidic arrangement comprising: a first section having a first plane and comprising a trigger channel and a stop channel, wherein the trigger channel and the stop channel are parallel with the first plane. The trigger channel has a first portion having a first depth, and a second portion having a second, deeper, depth, the trigger channel being arranged to allow a liquid flow to the second portion from the first portion. The stop channel has an opening that fluidically connects the stop channel to the second portion of the trigger channel at a predetermined distance from a bottom of the trigger channel. The microfluidic arrangement further comprises: a second section having a second plane having a third portion comprising a plurality of elongated recesses, wherein the plurality of recesses are arranged separated from each other; wherein the first section and the second section are arranged with the first and the second planes in parallel, and adjacent or coinciding, and such that the third portion overlaps the opening, or such that the third portion is adjacent to the opening, whereby a recess of the plurality of recesses is arranged to stop a liquid flow from the stop channel to the trigger channel.

By means of the microfluidic arrangement according to the first aspect, a liquid flowing in a stop channel may efficiently be stopped in the area of the opening that fluidically connects the stop channel to the second portion of the trigger channel. Further such a stopped flow of liquid in the stop channel may be triggered to flow into the trigger channel by a flow of liquid in the trigger channel. Further, by means of the present microfluidic arrangement, problems associated with air bubbles being introduced or trapped in the trigger channel may be minimised, avoided or handled.

The microfluidic arrangement of the first aspect may be comprising, comprised by or being a capillary trigger valve.

According to a second aspect of the present inventive concept there is provided a microfluidic trigger valve comprising: a trigger channel comprising a first side wall, a second side wall, a bottom surface and a top surface; the trigger channel having a first portion having a first distance between the bottom surface and the top surface, a second portion having a second distance between the bottom surface and the top surface, and a third portion having a third distance between the bottom surface and the top surface, the trigger channel being arranged to allow a liquid flow to the third portion from the first portion via the second portion; and a stop channel connecting to one of the first side wall and the second sidewall of the third portion of the trigger channel and arranged to stop a liquid flow from the stop channel to the trigger channel at the connection between the stop channel and the third portion of the trigger channel. The second distance is larger than the first distance by increasing one of a height and a depth of the trigger channel, and the third distance is larger than the second distance by increasing the other of a height and a depth of the trigger channel; wherein a ratio between the first distance and a length of the second portion is 0.9 or below; and a ratio between the second distance and a fourth distance from an interface between the second portion and the third portion to the connection between the stop channel and the trigger channel is 0.9 or below.

By means of the microfluidic trigger valve according to the second aspect, a liquid flowing in a stop channel may efficiently be stopped in the area of the opening that fluidically connects the stop channel to the third portion of the trigger channel. Further such a stopped flow of liquid in the stop channel may be triggered to flow into the trigger channel by a flow of liquid in the trigger channel. Further, by means of the present microfluidic arrangement, problems associated with air bubbles being introduced or trapped in the trigger channel may be minimised, avoided or handled.

According to a third aspect of the present inventive concept there is provided a microfluidic system comprising the microfluidic arrangement according to the first aspect, or the trigger valve according to the second aspect.

According to a fourth aspect of the present inventive concept there is provided a diagnostic device comprising the microfluidic system according to the third aspect.

Features of an aspect may apply to one or more of the other aspects.

### BRIEF DESCRIPTION OF THE DRAWINGS

The above and other aspects of the present inventive concept will now be described in more detail, with reference to appended drawings showing variants of the invention. The figures should not be considered limiting the invention to the specific variant; instead they are used for explaining and understanding the inventive concept.

As illustrated in the figures, sizes of components, such as channels, and regions may be exaggerated for illustrative purposes and, thus, be provided to illustrate the general structures of variants of the present inventive concept. Like reference numerals refer to like elements throughout.

FIG. 1 illustrates a side view of a comparing trigger valve.

FIGS. 2(a) and 2(b) illustrates a side view and a top view, respectively, of a microfluidic system according to an embodiment of the first aspect.

FIGS. 2(c) and 2(d) illustrates a side view and a top view, respectively, of a microfluidic system as illustrated in FIGS 2(a) and 2(b), further illustrated comprising an outlet channel.

FIGS. 3(a) to 3(c) illustrates top views of a microfluidic system according to embodiments of the first aspect.

FIG. 4 illustrates a side view of a microfluidic trigger valve according to an embodiment of the second aspect.

FIG. 5 illustrates a top view of a microfluidic trigger valve according to an embodiment of the second aspect.

FIG. 6 illustrates a side view of a microfluidic trigger valve according to an embodiment of the second aspect.

FIG. 7 illustrates a side view of a microfluidic trigger valve according to an embodiment of the second aspect.

### DETAILED DESCRIPTION

The present inventive concept will now be described more fully hereinafter with reference to the accompanying drawings, in which variants of the inventive concept are shown. The inventive concepts may, however, be implemented in many different forms and should not be construed as limited to the variants set forth herein; rather, these variants are provided for thoroughness and completeness, and fully convey the scope of the present inventive concept to the skilled person.

It is to be understood that this inventive concept is not limited to the particular component parts of the systems described as such systems may vary. It is also to be understood that the terminology used herein is for purpose of describing particular embodiments only and is not intended to be limiting. It must be noted that, as used in the specification and the appended claim, the articles “a”, “an”, “the”, and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings do not exclude other elements or steps.

It is to be understood that at least the stop channel and the trigger channel may be capillary channels. A capillary channel is a channel capable of providing a capillary-driven flow of a liquid. It is also to be understood that other channels and components of the system may be capillary channels and/or other types of channels depending on the specific implementation of the present inventive concept. Although a capillary channel is capable of providing a capillary-driven flow of a liquid, it is not excluded that other types of transport or forwarding of liquids may be used with the microfluidic channels. For example, pressure-assisted flows may be employed.

In the following, liquid may flow through channels and reach certain positions at different times within the microfluidic arrangement or trigger valve. Flow rates of flows may be controlled in different manners in order for the fluid to reach the positions at the described times. A capillary-driven flow of a fluid requires one or more contacting surfaces that the fluid can wet. For example, surfaces comprising glass or silica may be used for capillary-driven flows of aqueous liquids. Further, for example, suitable polymers with hydrophilic properties, either inherent to the polymer or by modification, including for example chemical modification or coating, may promote or enhance capillary driven flows. Capillary-driven flows, in addition to being dependent on materials of surfaces, is dependent on the liquid flowing. Attractive forces between the liquid and surfaces of channels have effect on a capillary-driven flow.

Further, capillary-driven flows may be controlled, for example, by adapting dimensions, including length, width and depth, of the channels and/or by adapting the flow resistances of the channels, and/or by adapting capillary driving forces or pressures. For example, the flow resistance of a channel may be controlled by adapting a cross-sectional area of the channel and/or the length of the channel. The flow resistance of a channel may, as indicated above, further be dependent on properties of the liquid, e.g. its dynamic viscosity. Additionally, or alternatively, the flow rate may be adapted by using flow resistors, for example flow resistors in a flow path of the liquid. A flow resistor may be a channel with a defined flow resistance in a flow path of the liquid.

To provide desired capillary forces or flows, dimensions of flow channels may be selected dependent on, for example, the liquid and properties of the liquid and/or material and/or properties of walls of the channels.

It shall further be understood that the terms “bottom surface”, “top surface”, “height” and “depth” of the trigger channel of the second aspect, as used herein, intends to be used for clarifying one typical use or orientation of the trigger channel. It is not excluded that the trigger channel could be turned, for example upside down, or, for example 90 degrees, and still be used and functioning.

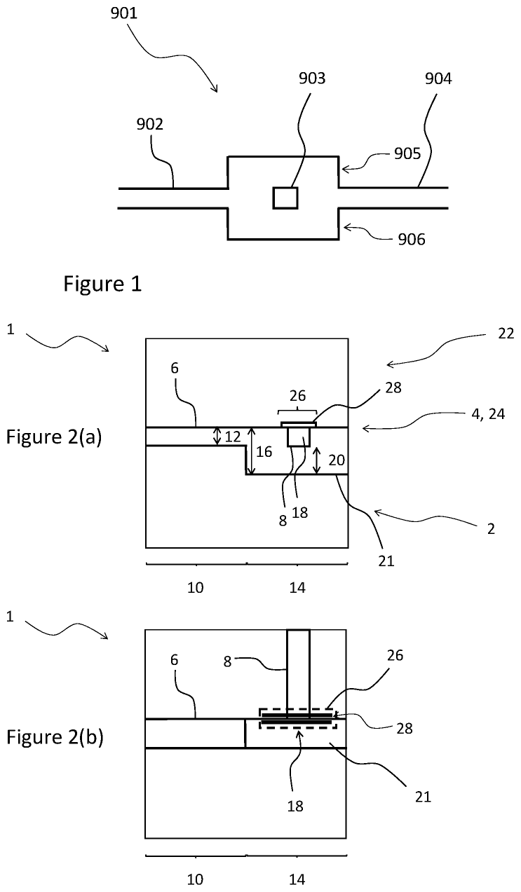

With reference to FIG. 1, a comparing capillary trigger valve 901 is illustrated and used herein as comparison to microfluidic arrangements and capillary trigger valves of the present concepts, and to be used for discussing disadvantages and problems related to prior art capillary trigger valves. FIG. 1 illustrates a side view of a the comparing trigger valve 901, having a comparing trigger channel 902, and a comparing stop channel 903 (of which comparing stop channel only its opening, mouthing into the comparing trigger valve 901, is illustrated as a square). Further illustrated is a comparing outlet channel 904, and a comparing recess 905 and a comparing deeper portion 906. In the present discussion, it is assumed that liquid flows in the comparing stop channel 903 in a direction out of the illustration, while, in the comparing trigger channel 902 liquid flows in a direction from left to right in FIG. 1. During use, it would be intended that liquid would be stopped from flowing in the comparing stop channel 903 as the liquid forefront reaches the comparing trigger channel 902, since capillary flow would be terminated as a result of reduced capillary force resulting from the abrupt widening of the comparing stop channel created by the comparing recess 905 and the comparing deeper portion 906. Further, it would be intended that the stopped liquid flow would be continued as a flow of liquid within the comparing trigger channel 902 reaches the opening of the stop channel.

The comparing trigger valve 901 is associated with problems including, but not limited to, that the liquid flow can be blocked or stopped in the triggering channel resulting from the increase in height where the comparing trigger channel 902 mouths into the part having the comparing recess 905 and the comparing deeper portion 906; and, further, a bubble can be trapped in the comparing recess 905 or in the comparing deeper portion 906 when the liquid flow in the comparing trigger channel 902 flows into the part having the recess an the deeper portion.

For trigger valves, stop channels and trigger channels, of aspects and embodiments of aspect, stopping of liquid flows may involve or require a minimum contact angle, such as, for example, a contact angle of 50° or above. Triggering may involve or require a maximum contact angle, such as, for example, a contact angle of 90° or below, such as 85° or below. Thereby, for example, stoppage at the end of the stop channel and a desirable flow in the triggering channel across the depth/height transitions may be ensured.

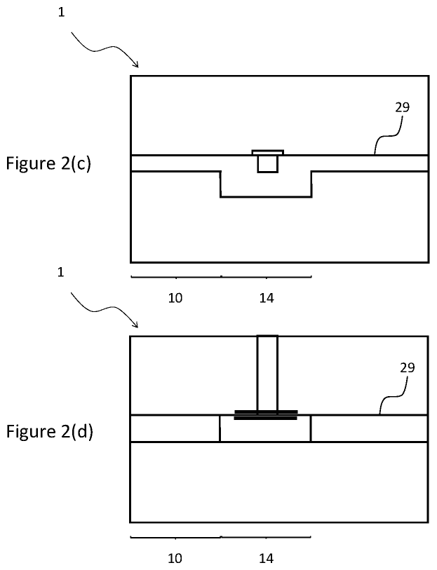

With reference to FIGS 2(a) and 2(b), the microfluidic arrangement 1 according to an example of the first aspect will now be discussed. FIG. 2(a) illustrates a side view of the microfluidic arrangement 1 and FIG. 2(b) illustrates a top view of the microfluidic arrangement 1, and references to both FIGS. 2(a) and 2(b) are made in the discussion below. The microfluidic arrangement 1 comprises: a first section 2 having a first plane 4 and comprising a trigger channel 6 and a stop channel 8, wherein the trigger channel 6 and the stop channel 8 are parallel with the first plane 4. The trigger channel 6 has a first portion 10 having a first depth 12, and a second portion 14 having a second, deeper, depth 16, the trigger channel 6 being arranged to allow a liquid flow to the second portion 14 from the first portion 10. The stop channel 8 has an opening 18 that fluidically connects the stop channel 8 to the second portion 14 of the trigger channel 6 at a predetermined distance 20 from a bottom 21 of the trigger channel 6. The microfluidic arrangement 1 further comprises: a second section 22 having a second plane 24 having a third portion 26 comprising a plurality of elongated recesses 28, wherein the plurality of recesses 28 are arranged separated from each other; wherein the first section 2 and the second section 22 are arranged with the first 4 and the second 24 planes in parallel, and adjacent or coinciding, and such that the third portion 26 overlaps the opening 18, or such that the third portion 26 is adjacent to the opening 18, whereby a recess of the plurality of recesses 28 is arranged to stop a liquid flow from the stop channel 8 to the trigger channel 6.

FIGS. 2(c) and 2(d) illustrates a side view and a top view, respectively, of a microfluidic arrangement 1 according to an example of the first aspect discussed above with reference to FIGS. 2(a) and (b). FIGS. 2(c) and 2(d) illustrates that the microfluidic arrangement 1 further may comprise or be connected to an outlet channel 29. The outlet channel 29, for example, allows liquid to flow out of the arrangement 1 and/or be contacted with, for example, other channels or arrangements. The outlet channel 29 may, as illustrated and exemplified with FIGS. 2(c) and 2(d), have a channel depth smaller than the second portion 14. Alternatively it may have a channel depth equal to or large than the second portion 14. For example, the outlet channel 29 may have a depth equal to the depth of the first portion 10.

By means of the microfluidic arrangement according to the first aspect, a liquid flowing in a stop channel may efficiently be stopped in the area of the opening that fluidically connects the stop channel to the second portion of the trigger channel. It has unexpectedly been realised that the trigger valve comprising the plurality of recesses allows efficient stopping of the flow in the stop channel 8 believed to be a result of at least one of the recesses providing an increase in height of the trigger channel 6 at the opening 18 of the stop channel 8, thereby halting capillary driven flow out of the stop channel 8. Further, any gasseous bubbles formed as liquid flowing in portion 14 of the trigger channel reaches the stop channel 8 to trigger the stopped flow are unexpectedly small and may be trapped and/or handled by the plurality of recesses. The plurality of recesses have an effect of acting to stop the flow in the stop channel 8. If a large recess would be used covering the same footprint as the plurality of recesses, instead of the plurality of recesses for the sake of comparing, there would be a risk of bubbles being formed and disturbing within the microfluidic arrangement and systems which may be connected thereto. For example, with a comparing trigger valve 901, as discussed and illustrated with reference to FIG. 1, large bubbles may form, for example in the comparing recess 905 as liquid flow is generated in the comparing deeper portion 906, which triggers the flow in the comparing stop channel 903 before the comparing recess 905 has filled with liquid. With analoguous reasoning, bubbles may form in the comparing deeper portion 906. Further, with the comparing trigger valve 901, capillary driven liquid flow may be terminated or stopped at a point where the comparing trigger channel 902 abruptly expands while entering the comparing recess 905 and the comparing deeper portion 906.

Properties of the plurality of recesses, for example plurality, shape and/or sizes of the recesses, may provide benefits with the microfluidic arrangement 1.

The microfluidic arrangement 1 may be characterised by a spacing distance between (i) an interface between the first portion 10 and the second portion 14 on the one hand, and (ii) the third portion 26 on the other hand. A ratio between the first distance 12 and the spacing distance may be 0.9 or below, such as within the range of 0.9 to 0.1. The ratio may be selected dependent on wettability of the liquid on the surfaces of the material of the first section 2. Thereby, risk of bubble formation in the second portion 14 or stopping of the flow within the microfluidic arrangement may be reduced. A recess of the plurality of recesses 28 being arranged to stop a liquid flow from the stop channel 8 to the trigger channel 6 may be seen as provision of an abrupt increase in height (upwards in FIG. 2(a)) above the opening 18, created by the recess, thus enabling termination of capillary flow.

In the illustrated example of FIGS. 2(a) and 2(b), the plurality of recesses are two recesses, although the number of recesses may be different, for example, two or more, such as 3 or more, for example 3-10 recesses. Further in the illustrated example, the recesses are straight and oriented parallel to the trigger channel. The recesses may have other orientations and non-straight shapes, for example one, more or all of the plurality of recesses may be curved. Further, the plurality of recesses may be arranged in non-parallel orientations. The illustrated plurality of recesses are arranged separated from each other, and it shall be realised and appreciated that two or more, for example all of, the recesses of the plurality of recesses may be viewed and as arranged separated from each other, but, for example, connected via channels or other recesses via, for example, edges of the recesses.

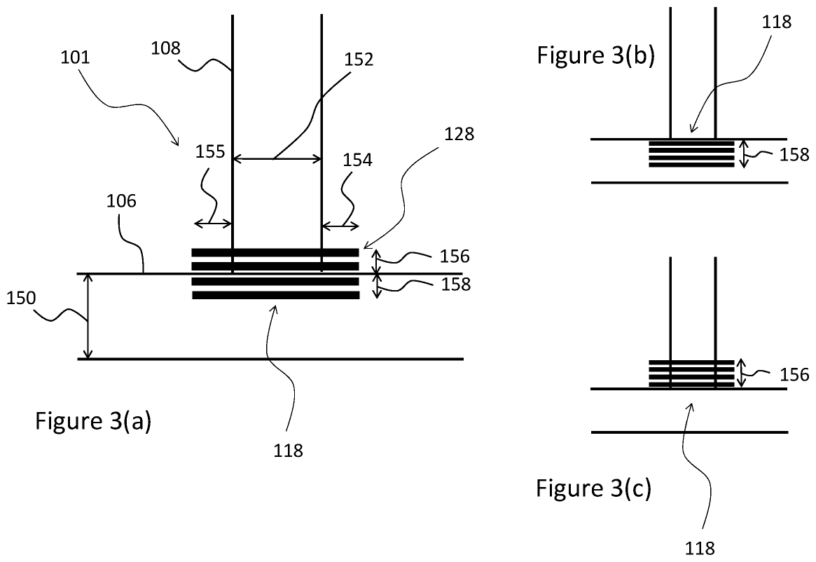

The third portion 26 being adjacent to the opening 18, may be wherein a recess of the plurality of recesses 26 having a shortest distance to the opening is not more than 2 micrometres away from the opening. With reference to FIG. 3(b) or 3(c), illustrating an arrangement as top views, this would be the closest distance between the slit closest to the opening 118, and a side wall of the channel having the opening.

The microfluidic arrangement may be manufactured as one block using suitable manufacturing teqnique.

Although, for example, FIG. 2(b) illustrates that the stop channel 8, may be arranged to connect to the trigger channel 6 at a right angle as seen from a top view, it shall be realised and appreciated that this is only an example and that the stop channel 8 may be arranged to connect to the trigger channel 6 at other angles, such as angles between, for example, 60-90 degrees, for example 50 degrees.

The first section may be a first substrate having a first surface, wherein the trigger channel and the stop channel are open to, and parallel with, the first surface; wherein the second section may be a second substrate having a second surface comprising the third portion; wherein the first substrate and the second substrate are arranged by contacting the first surface and the second surface such that the third portion of the second surface overlaps the opening, or such that the third portion is adjacent to the opening, whereby a recess of the plurality of recesses is arranged to stop a liquid flow from the stop channel to the trigger channel.

Thereby, the microfluidic arrangement may be provided or manufactured by combining or contacting two separate substrates. Such manufacturing may be beneficial, for reasons including, for example, efficient manufacturing of channels, recesses and/or deeper portions at different levels of the microfluidic arrangement. The plurality of recesses adds benefits to the microfluidic arrangement by providing tolerance to misalignment or by tolerating lesser precision during mating or contacting of the first and the second substrates during manufacturing of the microfluidic arrangement, while maintaining small volumes available for gaseous bubbles during use of the microfluidic arrangements. This shall be understood when considering that the plurality of recesses may be manufactured having a low volume as compared to if the plurality of recesses was replaced with a single wider recess, and when considering the unexpected discovery that it is sufficient that one of the plurality of recesses is adjacent to the opening of the stop channel to stop a flow therefrom.

Each of the plurality of recesses may be straight.

The recesses may alternatively have non-straight shapes, for example one, more or all of the plurality of recesses may be curved, such as having circular shapes or elliptical shapes.

The plurality of recesses may be arranged in parallel and separated along a direction transverse to the elongation of the recesses.

The elongations of the recesses may be parallel to an elongation of the trigger channel.

Thereby, efficient stopping of a flow of liquid in the stop channel may be realised.

The first substrate and the second substrate, further, may be arranged such that the elongations of the recesses are parallel to an elongation of the trigger channel.

The plurality of recesses may be separated from each other along a direction transverse to the elongation of the recesses.

Thereby, a lower precision during positioning and contacting of the first substrate and the second substrate during preparation or manufacturing of the microfluidic arrangement may be required and tolerated.

The plurality of recesses may comprises 2 to 10 number of recesses, such as 2 to 5 number of recesses.

Each of the plurality of recesses may reach at least 1 micrometer into the second section, or second substrate, and/or wherein each of the plurality of recesses is at least 1 micrometer wide.

Such measurements of the recesses allows for desirable stopping of the liquid flow in the stop channel.

Each of the plurality of recesses may have a depth of at least 1 micrometer.

Each recess of the plurality of recesses may have a width, transverse the elongation of the recess, of 1 micrometer or more, such as within 2-10 micrometres. Each recess of the plurality of recesses may have a length or elongation between 10 and 100 micrometres, for example 25 and 100 micrometres, such as 50 and 120 micrometres.

The first depth of the trigger channel may be 20-300 micrometres, such as 75-200, or 100-180 micrometres.

A width of the trigger channel may be 10-300 micrometres, such as 25-125, or 30-100 micrometres.

A depth of the stop channel may be 10-100 micrometres, such as 25-75, or 30-50 micrometres.

A width of the stop channel may be 5-100 micrometres, such as 10-75, or 10-50 micrometres.

The lengths of the plurality of recesses may be selected such that the plurality of recesses may overlap the width of the stop channel at the opening with 1 micrometres or more, such as 1-50 micrometres, or 5-25 micrometres, on each side of the stop channel.

FIG. 3(a) schematically illustrates an example of the microfluidic arrangement 101 as seen in a top view and having an overlap of the plurality of recesses 128, together with indications of selected dimensions of channels and recesses. The trigger channel 106 has a width 150, and the stop channel 108 has a width 152. The plurality of recesses overlap the width of the stop channel 108, on both sides of the stop channel 108, at the opening 118 with distances 154 and 155 which may be 1 micrometres or more, on each side of the stop channel 108, whereby a recess of the plurality of recesses 28 is arranged to stop a liquid flow from the stop channel 108 to the trigger channel 106. Distances 154 and distance 155 may be different, for example, distance 154 may be 1 micrometer and distance 155 may be 3 micrometer.

The overlap of the junction between the stop channel 108 and the trigger channel 106 may further be characterised by distances or overlaps 156 and 158. Overlaps 156 and 158 are measured from the side wall of the trigger channel 106 in contact with the stop channel 108. Overlap 156 defines an overlap over the stop channel in a longitudinal direction of the stop channel 108, which may comprise from 0 recesses to the total number of plurality of recesses, such as from 0 to 10 recesses. Overlap 158 defines an overlap over the trigger channel 106 transversal the longitudinal direction of the trigger channel 106, which may comprise from 0 recesses to the total number of plurality of recesses, such as from 0 to 10 recesses. If one of overlap 156 or 158 comprises 0 recesses, the plurality of recesses or the third portion 26 may be considered to be adjacent to the opening 118. FIGS. 3(b) and 3(c) schematically illustrates overlap 156 comprising 0 recesses and overlap 158 comprising 0 recesses, respectively, wherein the plurality of recesses or the third portion 26 are considered to be adjacent to the opening 118.

With further reference to FIG. 3(a), and an alternative embodiment, the plurality of recesses may have extensions such that they do not overlap the full width of the stop channel, i.e. that one or more of distances 154 and 155 may be negative or may extend inwards towards the center of the stop channel 108, from the side wall(s) of the stop channel.

The predetermined distance from the bottom of the trigger channel may be at least 1 micrometer, such as at least 10 micrometres, or at least 60 micrometres. The predetermined distance may be from the bottom of the trigger channel to a bottom of the stop channel.

The predetermined distance from the bottom of the trigger channel may be below 290 micrometres.

Such predetermined distance allows for desirable stopping of the liquid flow in the stop channel.

The distance between adjacent recesses of the plurality of recesses may be 1-5 micrometres, such as between 2 to 5 micrometres.

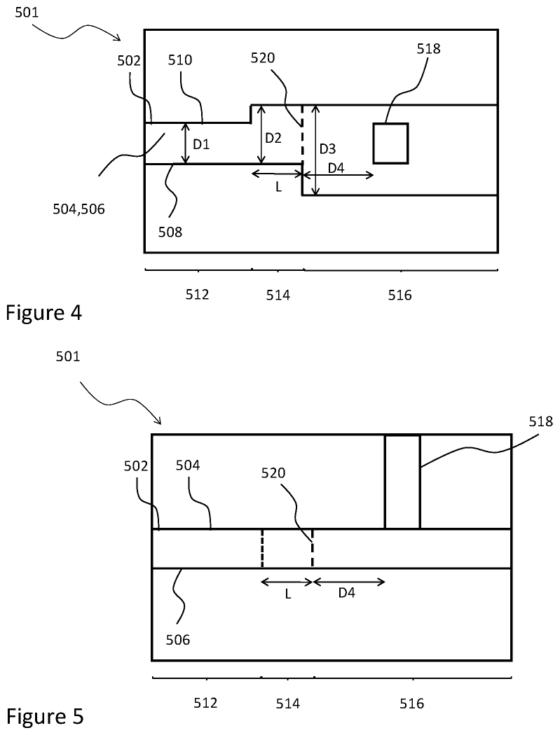

With reference to FIG. 4, a microfluidic trigger valve 501 according to an embodiment of the second aspect will now be discussed. Illustrated is a microfluidic trigger valve 501 as seen in a side view and comprising: a trigger channel 502 comprising a first side wall 504, a second side wall 506, a bottom surface 508 and a top surface 510; the trigger channel 502 having a first portion 512 having a first distance D1 between the bottom surface 508 and the top surface 510, a second portion 514 having a second distance D2 between the bottom surface 508 and the top surface 510, and a third portion 516 having a third distance D3 between the bottom surface and the top surface, the trigger channel 502 being arranged to allow a liquid flow to the third portion 516 from the first portion 512 via the second portion 514; and a stop channel 518 connecting to one of the first 504 side wall and the second 506 sidewall of the third portion 516 of the trigger channel 502 and arranged to stop a liquid flow from the stop channel 518 to the trigger channel 502 at the connection between the stop channel 518 and the third 516 portion of the trigger channel 502. The second distance D2 is larger than the first distance D1 by increasing one of a height and a depth of the trigger channel 502, and the third distance D3 is larger than the second distance D2 by increasing the other of a height and a depth of the trigger channel 502; wherein a ratio D1:L between the first distance and a length L of the second portion is 0.9 or below, such as 0.5 or below; and a ratio D2:D4 between the second distance D2 and a fourth distance D4 from an interface 520 between the second portion and the third portion to the connection between the stop channel and the trigger channel is 0.9 or below, such as 0.5 or below.

As discussed herein, the height being understood as directed towards the top of the illustration or capillary trigger valve in FIG. 4 and the depth being understood as directed towards the bottom of the illustration or capillary trigger valve in FIG. 4. The height may be directed towards and orthogonal to the top surface 510. The depth may be directed towards and orthogonal to the bottom surface 510.

The fourth distance D4 from the interface 520 between the second portion and the third portion to the connection between the stop channel and the trigger channel may be measured or defined from a cross-sectional plane between the second portion 514 and the third portion 516 and transverse the bottom surface 508 and one the first and second side walls 504, 506 at a point of the one the first and second side walls 504, 506 to which the stop channel 518 connects, to a closest wall or side surface of the stop channel 518.

The fourth distance D4 may be the shortest distance from the interface 520 between the second portion and the third portion to the connection between the stop channel and the trigger channel. Such a shortest distance is illustrated, for example, in FIGS. 4 and 5.

It shall be realised that the embodiment of the trigger valve 501 according to the second aspect as discussed with reference to FIG. 4 was illustrated with the second distance D2 being larger than the first distance D1 by increasing a height of the trigger channel 502, and the third distance D3 being larger than the second distance D2 by increasing the depth of the trigger channel 502. Although not illustrated in FIG. 4, the second distance D2 may, alternatively, be larger than the first distance D1 by increasing a depth of the trigger channel 502, and the third distance D3 may be larger than the second distance D2 by increasing the height of the trigger channel 502, and still be within the scope of the first aspect.

In an alternative aspect, D1 may equal D2.

It shall further be realised that although top views of embodiments of the microfluidic arrangement and the microfluidic trigger valve may be illustrated with trigger channels and stop channels having constant widths, the channels according to embodiments may have varying widths, such as being tapered or having tapered portions.

For example when one or more channels of the microfluidic trigger valve or the microfluidic arrangement are provided between two wafers, substrates or sections, the portion of the channel provided by one of the wafers, substrates or sections may have a different width as compared to the portion of the channel provided by the other one of the wafers, substrates or sections, which may result in channels having a different width within a crossection, or e.g. a different width at the top as compared to the bottom of the channel. Such arrangements may benefit from more efficient alignment during manufacturing of the microfluidic trigger valve or the microfluidic arrangement.

FIG. 5 illustrates the embodiment of the capillary trigger valve 501 discussed with reference to FIG. 4 in a top view instead of the side view illustrated in FIG. 4, to improve understanding of the trigger valve. In FIG. 5 the trigger channel 502, the stop channel 518, and the length L, the distance D4, and the first, second and third portions 512, 514, 516 are indicated together with first and second side walls 504 and 506. Transitions, or interfaces, between the first, second and third portions 512, 514, 516 are indicated with dotted lines.

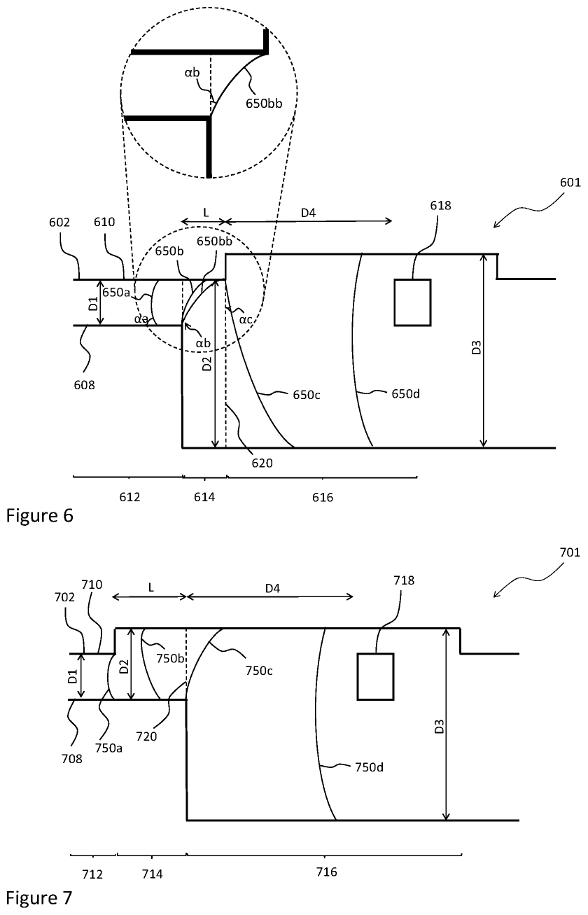

By means of the microfluidic trigger valve according to the second aspect, a liquid flowing in a stop channel may efficiently be stopped in the area of the opening that fluidically connects the stop channel to the third portion of the trigger channel. Further such a stopped flow of liquid in the stop channel may be triggered to flow into the trigger channel by a flow of liquid in the trigger channel. Further, by means of the present microfluidic trigger valve, problems associated with air bubbles being introduced or trapped in the trigger channel as well as problems associated with flow stoppage at transitions between the portions in the trigger channel may be minimised or avoided as will be explained below with reference to FIG. 6. The liquid flowing in the stop channel may efficiently be stopped resulting from an abrupt change in geometry of a wetting surface for capillary flows at the opening.

In FIG. 6 an embodiment of capillary trigger valve 601 is illustrated in a side view, wherein the second distance D2 being larger than the first distance D1 by increasing a depth of the trigger channel 602, and the third distance D3 being larger than the second distance D2 by increasing the height of the trigger channel 602. Similar to what was discussed with reference to FIG. 4, the trigger channel 602 comprises a bottom surface 608 and a top surface 610. The trigger channel 602 is further illustrated with a first portion 612 having a first distance D1 between the bottom surface 608 and the top surface 610, a second portion 614 having a second distance D2 between the bottom surface 608 and the top surface 610, and a third portion 616 having a third distance D3 between the bottom surface 608 and the top surface 610. The trigger channel 602 is arranged to allow a liquid flow to the third portion 616 from the first portion 612 via the second portion 614, i.e. in a direction from left to right in FIG. 6. A stop channel 618 is illustrated connecting to one of the first side wall and the second sidewall (not pointed out in FIG. 6) of the third portion 616 of the trigger channel 602 and arranged to stop a liquid flow (not illustrated in FIG. 6) from the stop channel 618 to the trigger channel 602 at the connection between the stop channel 618 and the third 616 portion.

Further illustrated in FIG. 6 are schematic liquid forefronts, or interfaces, 650a-650d (between liquid, to the left of the forefront in FIG. 6, and gaseous medium, for example air, to the right of the forefront in FIG. 6) at different consecutive times, 650a appearing first and 650d latest. At forefront 650a liquid flows within the first portion 612 and has not yet reached the second portion 614, and has a schematically illustrated contact angle α a. When the second portion 614 is reached by the forefront, the increased depth results in an abrupt change of the geometry (expansion) of the wetting surface for capillary flow, which results in holding back the advancing forefront at this point at the bottom surface 608, whereby, at the top surface 610, no change of geometry is present, with the overall result of a forefront resembling that schematically illustrated with forefront 650b. If the height of the trigger channel would have been increased instead of the depth, the opposite would have occurred, i.e. the forefront would be held back at the top surface 610. Downstream and later in time, illustrated with forefront 650c, the interface between the second and third portions 614, 616 have been reached by the forefront 650c, where the advancement of the forefront is held back at the top surface 610, where the height of the trigger channel is increased from second distance D2 to third distance D3. The length L, defined by the length of the second portion 614, have an effect on the angle αb, of a forefront 650bb, as measured between the lower portion of the forefront and a normal (illustrated with a dotted line) to the trigger channel. A larger length L increases the angle αb, thus making the liquid more prone to reach and wet the bottom surface 608 of the second portion of the trigger channel 602 and for the forefront to proceed further as has happened with the forefront 650c, while a shorter length L decreases the angle αb making the forefront less prone to proceed further. The first distance D1 matters in that a larger first distance D1 decreases the angle αb, while a smaller distance D1 increases the angle αb. Inset in FIG. 6 is a blow-up of a portion of the trigger valve 601 inserted to more clearly illustrate angle αb and forefront 650bb.

It has been unexpectedly discovered and adds to benefits of the present trigger valve, that having a ratio D1:L, between the first distance D1 and the length L, being 0.9 or below, in particular 0.5 or below, allows that the forefront 650b, 650bb can make the transit to the bottom surface 608 of the second portion 614, thus avoiding or reducing risk of capillary flow interruption or termination. With the present microfluidic trigger valve, the forefront may proceed from a position indicated by forefront 650bb to forefront 650c.

It has, further, been unexpectedly discovered and adds to benefits of the present trigger valve, that having a ratio D2:D4, between the second distance D2 and the fourth distance D4, from the interface 620 between the second portion 614 and the third portion 616 to the connection between the stop channel and the trigger channel being 0.9 or below, in particular 0.5 or below, allows that the forefront 650c can make the transit to the top surface 610 of the third portion 616 before reaching the stop channel, thus enabling avoiding that a gasseous bubble is formed in the third portion at or close to the top surface 610, in particular at the top left corner of the microfluidic trigger valve as illustrated in FIG. 6. With the present microfluidic trigger valve, a forefront schematically illustrated with forefront 650d may be provided before the forefront reaches and triggers the stop channel 618, thus bubble formation may be avoided.

It has been discovered and determined for the present inventive concepts that ratios D1:L and D2:D4 each being below 0.9 results in efficient transitions of flow with reduced risk of flow interruptions and bubble formation within the trigger valve 601.

In FIG. 7 another example of a capillary trigger valve 701 is illustrated as a side view, wherein the second distance D2 being larger than the first distance D1 by increasing a height of the trigger channel 702, and the third distance D3 being larger than the second distance D2 by increasing the depth of the trigger channel 702. Similar to what was discussed with reference to FIGS. 4 and 6, the trigger channel 702 comprises a bottom surface 708 and a top surface 710; the trigger channel 702 is further illustrated with a first portion 712 having a first distance D1 between the bottom surface 708 and the top surface 710, a second portion 714 having a second distance D2 between the bottom surface 708 and the top surface 710, and a third portion 716 having a third distance D3 between the bottom surface 708 and the top surface 710. The trigger channel 702 is arranged to allow a liquid flow to the third portion 716 from the first portion 712 via the second portion 714, i.e. in a direction from left to right in FIG. 7. A stop channel 718 connecting to one of the first side wall and the second sidewall (not pointed out in FIG. 7) of the third portion 716 of the trigger channel 702 and arranged to stop a liquid flow (not illustrated in FIG. 7) from the stop channel 718 to the trigger channel 702 at the connection between the stop channel 718 and the third 716 portion.

Further illustrated in FIG. 7 are schematic liquid forefronts, or interfaces, 750a-750d (between liquid, to the left of the forefront in FIG. 7, and gaseous medium, for example air, to the right of the forefront in FIG. 7) at different consecutive times, 750a appearing first and 750d latest. At forefront 750a liquid has flown within the first portion 712 and has reached the second portion 714, whereby the increased height results in abrupt change of the geometry (expansion) of the wetting surface for capillary flow, which results in holding back the advancing forefront at this point of the top surface 710, wherein, adjacent to the bottom surface 708 the forefront advances, resulting in a forefront resembling or being similar to that illustrated with forefront 750b once the second portion 714 has been entered. If the depth of the trigger channel 702 would have been increased instead of the height, the opposite would have occurred, i.e. the forefront would be held back at the bottom surface 708. Downstream and later in time, illustrated with forefront 750c, the interface between the second and third portions 714, 716 have been reached by the forefront 750c, where the advancement of the forefront is held back at the bottom surface 708, as the depth of the trigger channel is increased from second distance D2 to third distance D3. Effects of angles between the forefronts and the trigger channel, and effects of length L and the first distance D1 were discussed with reference to FIG. 6. It is noted that it has been unexpectedly discovered and adds to benefits of the present trigger valve, that having a ratio between the second distance D2 and the fourth distance D4 from the interface 720 between the second portion 714 and the third portion 716 to the connection between the stop channel and the trigger channel being 0.9 or below, in particular 0.5 or below, for example allows that the forefront 750c can make the transit to the bottom surface 708 of the third portion 716 before reaching the stop channel, thus enabling avoiding that a gasseous bubble is formed in the third portion at or close to the bottom surface 708, in particular at the lower left corner of the microfluidic trigger valve 701 as illustrated in FIG. 7. With the present microfluidic trigger valve, a forefront schematically illustrated with forefront 750d may be provided before the forefront reaches and triggers a flow in the stop channel 718. It has, further, been discovered and determined for the present inventive concepts that ratios D1:L being below 0.9 results in efficient transitions of flow from the first portion 712 to the second portion 714, with reduced risk of flow interruptions within the trigger valve 701.

It has further been unexpectedly realised that the ratio between the first distance D1 and a length L of the second portion being 0.9 or below, in particular 0.5 or below, in combination with other definitions of a trigger valve according to the second aspect, the forefront may transition from the first portion 512, 612, 712, and into the second portion 514, 614, 714 with reduced risks of flow stop within the trigger channel 502, 602, 702, as compared to a ratio outside the defined ranges. Outside those ratios, i.e. above 0.9, there is a high risk of the flow stopping in the trigger channel and not make the transit into the to second portion 514, 614, 714. With the combined features of the microfluidic trigger valve according to the second aspect, and embodiments thereof, unintentional flow stop and bubble formation within the microfluidic trigger valve may be avoided or minimised.

The trigger channel may further comprise structures assisting or increasing a capillary driven pull of liquid from one portion to another portion of the trigger channel. Thereby, for example, transition of liquid from the first portion 512, 612, 712 into the second portion 514, 614, 714 may be provided with further reduced risks of flow stop.

The stop channel may connect to one of the first side wall and the second sidewall at least 1 micrometer distance from the bottom surface and at least 1 micrometer distance from the top surface, of the third portion. The at least 1 micrometer distance from the bottom surface may be defined from the bottom surface to a bottom of the opening of the stop channel; and the at least 1 micrometer distance from the top surface may be defined from the top surface to a top of the opening of the stop channel.

The stop channel may connect to one of the first side wall and the second sidewall at least 10 micrometres, or at least 60 micrometres distance from the bottom surface and at least 10 micrometer, or at least 60 micrometres distance from the top surface, of the third portion. The stop channel may connect to one of the first side wall and the second sidewall at below 100 micrometres distance from the bottom surface and at below 100 micrometres distance from the top surface, of the third portion. Thus, efficient stopping of the liquid flow in the stop channel may be achieved, and suitable heights/depth of the channels may be realised.

A shortest distance between the stop channel and the top surface may be equal to the increased height of the trigger channel. Such shortest distance may be realised, for example, by manufacturing the trigger valve from two wafers or other structures wherein the stop channel is provided in one of the wafers/structures and the increased height is realised by providing a recess in the other of the wafers/structures.

A shortest distance between the stop channel and the bottom surface may be equal to the increased depth of the trigger channel.

The trigger channel may further comprise a fourth portion, wherein the trigger channel being arranged to allow a liquid flow to the fourth portion from the first portion via the third portion, wherein the fourth portion having a fourth distance between the bottom surface and the top surface, the fourth distance being smaller than the third distance by decreasing a height and/or depth of the trigger channel.

The second distance may be larger than the first distance by increasing the height of the trigger channel.

One example of such a microfluidic trigger valve is illustrated in FIG. 7.

The second distance may be larger than the first distance by increasing the depth of the trigger channel.

One example of such a microfluidic trigger valve is illustrated in FIG. 6.

According to an alternative to the capillary trigger valve according to the second aspect, there may be provided a capillary trigger valve wherein the trigger channel is not divided in first second and third portions having distances D1, D2 and D3 respectively, but wherein the trigger channel either is defined by the larger distance D3 or by going from D2 to D3 without having the smaller distance D1.

According to a third aspect of the present inventive concept there is provided a microfluidic arrangement comprising the microfluidic arrangement according to the first aspect, or the trigger valve according to the second aspect.

According to a fourth aspect of the present inventive concept there is provided a diagnostic device comprising the microfluidic arrangement according to the third aspect.

The person skilled in the art realizes that the present inventive concept by no means is limited to the preferred variants described above. On the contrary, many modifications and variations are possible within the scope of the appended claims. Additionally, variations to the disclosed variants can be understood and effected by the skilled person in practicing the claimed invention, from a study of the drawings, the disclosure, and the appended claims.

1. A microfluidic arrangement comprising:
a first section having a first plane and comprising a trigger channel and a stop channel, wherein the trigger channel and the stop channel are parallel with the first plane;
wherein the trigger channel has a first portion having a first depth, and a second portion having a second, deeper, depth, the trigger channel being arranged to allow a liquid flow to the second portion from the first portion; and
wherein the stop channel has an opening that fluidically connects the stop channel to the second portion of the trigger channel at a predetermined distance from a bottom of the trigger channel;
the microfluidic arrangement further comprising:
a second section having a second plane having a third portion comprising a plurality of elongated recesses, wherein the plurality of recesses are arranged separated from each other;
wherein the first section and the second section are arranged with the first and the second planes in parallel, and adjacent or coinciding, and such that the third portion overlaps the opening, or such that the third portion is adjacent to the opening, whereby a recess of the plurality of recesses is arranged to stop a liquid flow from the stop channel to the trigger channel.

2. The microfluidic arrangement according to claim 1,
wherein the first section is a first substrate having a first surface, wherein the trigger channel and the stop channel are open to, and parallel with, the first surface;
wherein the second section is a second substrate having a second surface comprising the third portion;
wherein the first substrate and the second substrate are arranged by contacting the first surface and the second surface such that the third portion of the second surface overlaps the opening, or such that the third portion is adjacent to the opening, whereby a recess of the plurality of recesses is arranged to stop a liquid flow from the stop channel to the trigger channel.

3. The microfluidic arrangement according to claim 1, wherein each of the plurality of recesses are straight.

4. The microfluidic arrangement according to claim 1, wherein the plurality of recesses are being arranged in parallel and separated along a direction transverse to the elongation of the recesses.

5. The microfluidic arrangement according to claim 1, wherein the elongations of the recesses are parallel to an elongation of the trigger channel.

6. The microfluidic arrangement according to claim 2, wherein the first substrate and the second substrate, further, are arranged such that the elongations of the recesses are parallel to an elongation of the trigger channel.

7. The microfluidic arrangement according to claim 1, wherein the plurality of recesses are separated from each other along a direction transverse to the elongation of the recesses.

8. The microfluidic arrangement according to claim 1, wherein the plurality of recesses comprises 2 to 10 number of recesses.

9. The microfluidic arrangement according to claim 1, wherein each of the plurality of recesses reaches at least 1 micrometer into the second section, and/or wherein each of the plurality of recesses is at least 1 micrometer wide.

10. The microfluidic arrangement according to claim 1, wherein the predetermined distance from the bottom of the trigger channel is at least 1 micrometer.

11. The microfluidic arrangement according to claim 1, wherein a distance between adjacent recesses of the plurality of recesses is between 1-5 micrometres, such as between 2 to 5 micrometres.

12. A microfluidic trigger valve comprising:
a trigger channel comprising a first side wall, a second side wall, a bottom surface and a top surface,
the trigger channel having a first portion having a first distance (D1) between the bottom surface and the top surface, a second portion having a second distance (D2) between the bottom surface and the top surface, and a third portion having a third distance (D3) between the bottom surface and the top surface, the trigger channel being arranged to allow a liquid flow to the third portion from the first portion via the second portion; and
a stop channel connecting to one of the first side wall and the second sidewall of the third portion of the trigger channel and arranged to stop a liquid flow from the stop channel to the trigger channel at the connection between the stop channel and the third portion of the trigger channel; and
wherein the second distance (D2) is larger than the first distance (D1) by increasing one of a height and a depth of the trigger channel, and the third distance (D3) is larger than the second distance (D2) by increasing the other of a height and a depth of the trigger channel;
wherein a ratio between the first distance (D1) and a length (L) of the second portion is 0.9 or below; and
wherein a ratio between the second distance (D2) and a fourth distance (D4) from an interface between the second portion and the third portion to the connection between the stop channel and the trigger channel is 0.9 or below.

13. The microfluidic trigger valve according to claim 12, wherein the stop channel connecting to one of the first side wall and the second sidewall at least 1 micrometer distance from the bottom surface and at least 1 micrometer distance from the top surface, of the third portion.

14. The microfluidic trigger valve according to claim 12, wherein a shortest distance between the stop channel and the top surface is equal to the increased height of the trigger channel.

15. The microfluidic trigger valve according to claim 12, wherein the trigger channel further comprises a fourth portion, wherein the trigger channel being arranged to allow a liquid flow to the fourth portion from the first portion via the third portion, wherein the fourth portion having a fourth distance between the bottom surface and the top surface, the fourth distance being smaller than the third distance by decreasing a height and/or depth of the trigger channel.

16. The microfluidic trigger valve according to claim 12, wherein the second distance is larger than the first distance by increasing the height of the trigger channel.

17. The microfluidic trigger valve according to claim 12, wherein the second distance is larger than the first distance by increasing the depth of the trigger channel.

18. A microfluidic system comprising the microfluidic arrangement according to claim 1.

19. A diagnostic device comprising the microfluidic system according to claim 18.

20. A microfluidic system comprising the trigger valve according to claim 12.

21. A diagnostic device comprising the microfluidic system according to claim 20.
